(19) United States
(12) Patent Application Publication
(10) Pub. No.: US 2007/0076014 A1
(43) Pub. Date: Apr. 5, 2007

(54) Universal color decoder an method for decoding input signal for a multiple primary color display system

(75) Inventor: Adrianus J. S. De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/571,715

(22) PCT Filed: Sep. 27, 2004
(86) PCT No.: PCT/IB04/51869

§ 371 Date: Mar. 10, 2006

Related U.S. Application Data
(60) Provisional application No. 60/507,092, filed on Sep. 30, 2003.

(51) Int. Cl. G09G 5/02

(52) U.S. Cl. 345/597

(57) ABSTRACT

A decoder and method of decoding converts color image data into a format for display by a display having N primary colors, where N>3. Each of a plurality of input format converters converts an input signal having a corresponding color format to a set of X, Y, Z tristimulus values, and outputs the set of X, Y, Z tristimulus values. An input selector selects a selected set of X, Y, Z tristimulus values form one of the outputs of the input format converters, or a dedicated X, Y, Z input. An output converter converts the selected set of X, Y, Z tristimulus values into N color image pixel data corresponding to the N primary colors.

This invention pertains to the field of video and image signal processing and more particularly, to a system and a method of decoding video and input signals into multiple primary color signals.

It is believed that the human color perception is derived in large part from certain physical characteristics of the eye. In particular, the eye has three different types of “cones” for receiving light, each one of which process different colors of the spectrum differently. The three types of cones are generally referred to as cyanolabes, chlorolabes, and erytholabes. Cyanolabes are most sensitive to blue light, chlorolabes are most sensitive to green light, and erytholabes are most sensitive to red light. The chlorolabes and erytholabes are mostly packed into the fovea centralis region of the eye. The cyanolabes are mostly found outside the fovea. It is currently believed, based on measured response curves, that the typical human eye contains 6 to 7 million cones divided as follows: 64% erytholabes, 32% chlorolabes, and 2% cyanolabes.

Color matching studies carried out in the 1920s showed that colored samples could be matched by combinations of monochromatic primary colors Red (700 nm), Green (546.1 nm) and Blue (435.8 nm). The average responses of a large group of observers can be reproduced by a set of three color matching functions.

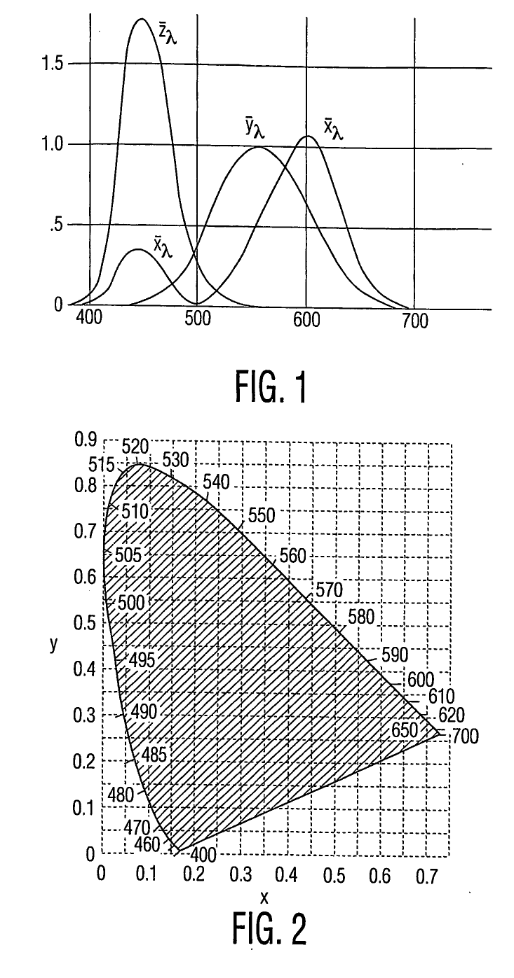

One set of commonly used color matching functions are the color matching functions of the Commission Internationale d'Eclairage (International Commission on Illumination) (CIE). FIG. 1 shows the CIE color matching functions.

Based on the fact that the human eye has three different types of color sensitive cones, as discussed above, the response of the eye can perhaps best be described in terms of three “tristimulus values,” usually denoted as X, Y and Z. From the CIE color matching functions, one can derive tristimulus values that specify the chromaticity. However, once this is accomplished, it is found that the colors can be expressed in terms of the two color coordinates x and y.

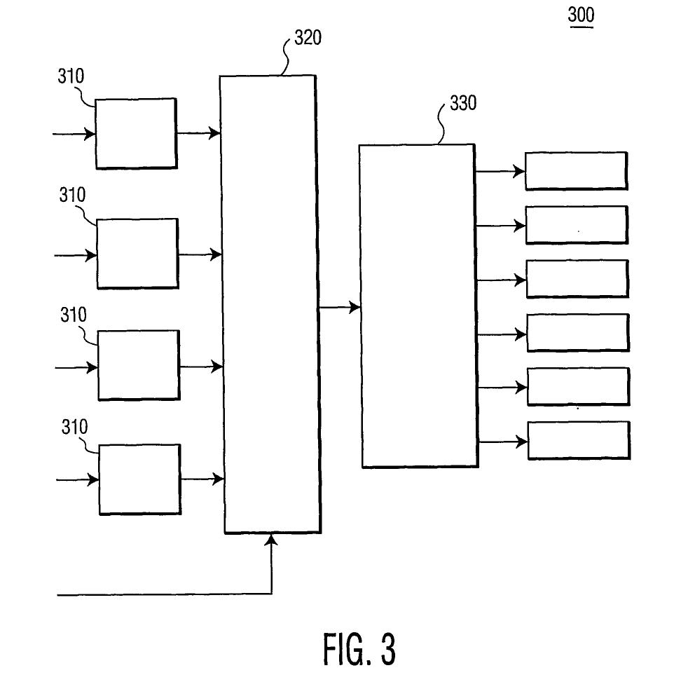

In 1931 the Commission Internationale d'Eclairage (International Commission on Illumination) (CIE) created a chromaticity diagram that maps the gamut of human color perception in terms of the two CIE parameters: x and y. FIG. 2 shows the 1931 CIE standard chromaticity diagram. The diagram includes all of the colors perceivable by the normal human eye. The spectral colors are distributed around the edge of the “color space” as shown, and that outline includes all of the perceived hues and provides a framework for investigating color.

Meanwhile, in general, existing color display devices display images and video using a set of only three primary colors, typically red (R), green (G), and blue (B). An existing display device combines the three primary colors with appropriate weightings to produce all of the various colors to be displayed.

A number of different standard formats have been established for video or image signals representing color image pixel data from a video or image source. Some of the more important formats include: European Broadcast Union (EBU) YUV video format, National Television Systems Committee (NTSC) YIQ video format, Society of Motion Pictures & Television Engineering-C (SMPTE-C) RGB video format, International Telecommunications Union (ITU) standard BT-709 HDTV studio production YCbCr video format, SMPTE-240M YPbPr video format, KODAK® PhotoYCC format, etc. According to the various formats, the video or image information may be in either digital or analog form.

The above-mentioned video and image formats were generally designed to operate with display systems that operate with three primary colors, as discussed above. The table below indicates the CIE chromaticity diagram coordinates for the R, G and B primary colors, and for “white,” for each of the standard formats mentioned above.

| FORMAT | RED | GREEN | BLUE | WHITE |
|---|---|---|---|---|
| EBU YUV | x = 0.64, | x = 0.29, | x = 0.15, | x = 0.3127, |
| | y = 0.33 | y = 0.60 | y = 0.06 | y = 0.329 |
| NTSC YIQ | x = 0.67, | x = 0.21, | x = 0.14, | x = 0.3101, |
| | y = 0.33 | y = 0.71 | y = 0.08 | y = 0.3162 |
| SMPTE-C | x = 0.63, | x = 0.31, | x = 0.155, | x = 0.3127, |
| | y = 0.34 | y = 0.595 | y = 0.07 | y = 0.329 |
| ITU BT-709 | x = 0.64, | x = 0.30, | x = 0.15, | x = 0.3127, |
| YCbCr | y = 0.33 | y = 0.600 | y = 0.06 | y = 0.329 |
| SMPTE-240M | x = 0.67, | x = 0.21, | x = 0.15, | x = 0.3127, |
| YPbPr | y = 0.33 | y = 0.71 | y = 0.06 | y = 0.329 |
| Photo YCC | x = 0.64, | x = 0.30, | x = 0.15, | x = 0.3127, |
| | y = 0.33 | y = 0.600 | y = 0.06 | y = 0.329 |

Meanwhile, as technology improves, there is an increasing demand for systems and devices that can display still images and video with greater color fidelity and brightness levels. Some applications where color fidelity and brightness demands are high include fashion design, digital photography, digital advertisement, medical imagery, home decoration, and art. Display systems that operate with more than three (3) primary colors are beginning to look interesting for these applications.

However, existing video and image sources using any of the standards described above do not provide video and image information in a format that is easily usable by a display device having more than three primary colors. Furthermore, as new video and image standards develop, there will be a need to convert data presented in these formats into a format suitable for a display systems operating with more than three primary colors.

Accordingly, it would be desirable to provide to a universal color decoder that can receive video and image signals representing color image pixel data in virtually any color format, and decode the data to a format for use by display having more than three primary colors. It would also be desirable to provide such a decoder that has a flexible architecture to readily accommodate future video and image formats that have not yet been created. The present invention is directed to addressing one or more of the preceding concerns.

In one aspect of the invention, a decoder for converting a format of an input signal into a format for a display having N primary colors, where N≧3, comprises: a plurality of input format converters each adapted to convert an input signal having a corresponding color format to a set of X, Y, Z tristimulus values, and to output the set of X, Y, Z tristimulus values; an input selector adapted to select one of the outputs of the input format converters, comprising a selected set of X, Y, Z tristimulus values; and an output converter adapted to convert the selected set of X, Y, Z tristimulus values into N color image pixel data corresponding to the N primary colors.

In another aspect of the invention, a method of converting an input signal into a format for a display having N primary colors, where N≧3, comprises selecting a set of X, Y, Z tristimulus values from among a plurality of inputs, and converting the selected set of X, Y, Z tristimulus values into color image pixel data corresponding to the N primary colors.

In yet another aspect of the invention, a method of converting an input signal into a format for a display having N primary colors, where N≧3, comprises: selecting a set of X, Y, Z tristimulus values from among a plurality of inputs; and converting the selected set of X, Y, Z tristimulus values into color image pixel data corresponding to the N primary colors.

Further and other aspects will become evident from the description to follow.

FIG. 1 shows the CIE color matching functions;

FIG. 2 shows the 1931 CIE standard chromaticity diagram;

FIG. 3 shows a block diagram of an embodiment of a universal color decoder; and

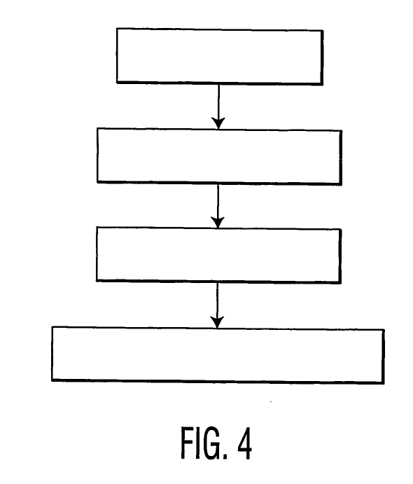

FIG. 4 shows a flowchart of a method of converting color image data into a format for display by a display having N primary colors, where N≧3.

FIG. 3 shows a block diagram of a universal color decoder 300. The universal color decoder 300 includes: a plurality of input format converters 310, an input selector 320, and an output format converter 330. Each input format converter 310 has an input and an output. The input selector 320 has a plurality of inputs and an output. The output format converter 330 has an input and a plurality of outputs. The output of each input format converter 310 is coupled to a corresponding one of the inputs of the input selector 320. The output of the input selector 320 is coupled to the input of the output format converter 330. The outputs of the output format converter 330 are each coupled to a corresponding color processing or driving circuit of a multi-primary color display device (not shown).

The operation of the universal color decoder 300 will now be explained.

Each input format converter 310 is adapted to receive an input signal representing color image pixel data in a corresponding color format for a corresponding color space. The input signal may be in either analog or digital format depending, for example, upon the particular standard employed. Beneficially, the input format converter 310 is adapted to convert the received signal into a set of Commission Internationale d'Eclairage (CIE) standard X, Y, Z tristimulus values, and to output the set of X, Y, Z tristimulus values. The universal color decoder 310 includes: a first input format converter 310 adapted to convert an input signal, representing color image pixel data in the European Broadcast Union (EBU) YUV color format, to the CIE X, Y, Z tristimulus values; a second input format converter adapted to convert an input signal, representing color image pixel data in the National Television Systems Committee (NTSC) YIQ color format, to the CIE X, Y, Z tristimulus values; a third input format converter adapted to convert an input signal, representing color image pixel data in the Society of Motion Pictures & Television Engineers-C (SMPTE-C) color format, to the CIE X, Y, Z tristimulus values; and a fourth input format converter adapted to convert an input signal having YCC color format to the CIE X, Y, Z tristimulus values. Additional input format converters 310 can be provided for any input signal that represents color image pixel data in a different color format. Beneficially, new input format converters 310 can be provided as needed whenever a new color format is developed or standardized. In each case, the input format converter 310 provides an output signal comprising the CIE X, Y, Z tristimulus values.

The CIE X, Y, Z tristimulus values may correspond to the 1931 CIE standard, or any later or future standard. Indeed, the universal color decoder may operate with any set of X, Y, Z tristimulus values based on color perception characteristics of the human eye, in which the input format converters are adapted to convert the color formats of the various input signals to the corresponding X, Y, Z tristimulus values.

Equations (1) through (3) below provide the necessary transformation for converting an input signal formatted for the EBU YUV color space into CIE X, Y, Z tristimulus values:
X=0.431(Y+1.140V)+0.342(Y−0.396U−0.581V)+0.178(Y+2.029U) 1)
Y=0.222(Y+1.140V)+0.707(Y−0.396U−0.581V)+0.071(Y+2.029U) 2)
Z=0.020(Y+1.140V)+0.130(Y−0.396U−0.581V)+0.939(Y+2.029U) 3)

Equations (4) through (6) below provide the necessary transformation for converting an input signal formatted for the NTSC YIQ color space into CIE X, Y, Z tristimulus values:
X=0.607(Y+0.956I+0.621Q)+0.174(Y−0.272I−0.647Q)+0.200(Y−1.105I+1.702Q) 4)
Y=0.299(Y+0.956I+0.621Q)+0.587(Y−0.272I−0.647Q)+0.114(Y−1.105I+1.702Q) 5)
Z=0.066(Y−0.272I−0.647Q)+1.116(Y−1.105I+1.702Q) 6)

Equations (7) through (9) below provide the necessary transformation for converting an input signal formatted for the SMPTE-C RGB color space into CIE X, Y, Z tristimulus values:
X=0.3935R+0.3653G+0.1916B 7)
Y=0.2124R+0.7011G+0.0866B 8)
Z=0.0187R+0.1119G+0.9582B 9)

Similarly appropriate equations may be used for input signals representing color image pixel data with other color formats.

The input format converters 310 may be realized in hardware and/or software, for example with analog or digital filters (as appropriate), with a microprocessor, with a digital signal processor, with an application specific integrated circuit (ASIC), etc.

The input selector 320 is adapted to select an input signal provided at one of its inputs, and outputs the selected signal, comprising a selected set of X, Y, Z tristimulus values. The selection may be made under user control, or it may be done automatically, for example, by determining which input is receiving a signal comprising a set of X, Y, Z tristimulus values when only one input is being used. The input selector 320 may be a multiplexer or a switch.

Beneficially, the input selector 320 has a dedicated input which is adapted to receive an externally supplied input signal that is already in the X, Y, Z tristimulus values format. This enables the use of the maximum color gamut that the display system can handle. This is particularly advantageous for wide color gamut display systems. Such wide color gamut systems, which may operate with more than three primary colors, are particularly beneficial for certain demanding professional application such as fashion design, art, point-of-sale display; etc. A direct X, Y, Z input is advantageous when processing signals, for example, received from a digital camera. A digital camera may include a charge coupled device (CCD) chip that captures images using filters that simulate the eye sensitivity curves as closely as possible. In that case, there would be no need to convert the X, Y, Z signals that originate in the camera to any other color signal prior to the output format decoder 330.

The output format converter 330 is adapted to convert the selected set of X, Y, Z tristimulus values into an output signal suitable for driving a display device having more than three primary colors. Beneficially, the output signal comprises individual color data for individual color channels for each of N primary colors, where N≧3. Since different display devices can and will use different color elements and therefore have different primary color points, and/or a different number of colors, N, it is seen that the output format converter 330 is tailored to the parameters of a particular display device. If it is desired to simultaneously drive two or more different models or types of display devices, then the universal color decoder 300 should include two or more different output format converters 330, all operating on the same of X, Y, Z tristimulus values input data, but each producing output data suitable for a corresponding display device.

For simplicity of discussion, we will refer to the data for the N primary colors as comprising N color image pixel data, and the data for each color will be referred to as Pᵢ where i 0 {1, N}.

As can be seen, the number of primary colors is greater than the number of tristimulus values. So, in some cases, a single X, Y, Z tristimulus set can be mapped to more than one set of values for Pᵢ:i 0 {1, N}. In such cases, the output format converter 330 may use a variety of rules to determine which set of for Pᵢ:i 0 {1, N} to output. For example, a display may include one or more color elements having color points at or near the edge of the CIE chromaticity diagram (highly saturated colors), and one or more other color elements having color points closer to the center of the CIE chromaticity diagram but capable of higher lumen outputs (greater brightness). In that case, the output format converter 330 may be designed to convert the selected X, Y, Z tristimulus value data into N color image pixel data having a highest total lumen output (greatest brightness). However, other rules may be employed instead.

FIG. 4 shows a flowchart of a method of converting color image data into a format for display by a display having N primary colors, where N≧3. The method of FIG. 4 may be executed using the universal color decoder 300.

As can be seen from the description above, the universal color decoder 300 first converts any input signal to the X, Y, Z tristimulus values, and then converts the X, Y, Z tristimulus values into display-specific color image pixel data for the N primary color display. Thus, the input signal format and the output signal format have been decoupled from each other. This provides several benefits. First, whenever a display device is changed (e.g., to a device either have a different number of colors N, or different color elements with different color points), it is relatively easy to modify the universal color decoder 300 by changing the parameters of only the output converter 330. Meanwhile, the input format converters 310 and the input selector 320 could remain unchanged. Second, whenever a new video or image format is developed or standardized, the universal color decoder 300 can be updated by providing only one new input format converter 310 for the new format. The other input format converters 310, the input selector 320, and the output format converter 330 could remain unchanged.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

1. A decoder for converting a format of an input signal into a format for a display having N primary colors, where N≧3, the decoder comprising:
a plurality of input format converters each adapted to convert an input signal having a corresponding color format to a set of X, Y, Z tristimulus values, and to output the set of X, Y, Z tristimulus values;
an input selector adapted to select a selected set of X, Y, Z tristimulus values; and
an output converter adapted to convert the selected set of X, Y, Z tristimulus values into N color image pixel data corresponding to the N primary colors.

2. The decoder of claim 1, where the plurality of input format converters includes a first input format converter adapted to convert an input signal having a European Broadcast Union (EBU) YUV color format to the X, Y, Z tristimulus values.

3. The decoder of claim 2, where the plurality of input format converters includes a second input format converter adapted to convert an input signal having a National Television Systems Committee (NTSC) YIQ color format to the X, Y, Z tristimulus values.

4. The decoder of claim 3, where the plurality of input format converters includes a third input format converter adapted to convert an input signal having a Society of Motion Pictures & Television Engineers-C (SMPTE-C) RGB color format to the X, Y, Z tristimulus values.

5. The decoder of claim 4, where the plurality of input format converters includes a fourth input format converter adapted to convert an input signal having an International Telecommunications Union (ITU) standard BT-709 YCbCr color format to the X, Y, Z tristimulus values.

6. The decoder of claim 2, where the plurality of input format converters includes an input format converter adapted to convert an input signal having a National Television Systems Committee (NTSC) YIQ color format to the X, Y, Z tristimulus values.

7. The decoder of claim 2, where the plurality of input format converters includes an input format converter adapted to convert an input signal having a Society of Motion Pictures & Television Engineers-C (SMPTE-C) color format to the X, Y, Z tristimulus values.

8. The decoder of claim 2, where the plurality of input format converters includes an input format converter adapted to convert an input signal having an International Telecommunications Union (ITU) standard BT-709 YCbCr color format to the X, Y, Z tristimulus values.

9. The decoder of claim 1, where N>3.

10. A display system including a display, and the decoder of claim 1 providing the N color image pixel data to the display.

11. A method of converting an input signal into a format for a display having N primary colors, where N≧3, the method comprising:
selecting a set of X, Y, Z tristimulus values from among a plurality of inputs; and
converting the selected set of X, Y, Z tristimulus values into color image pixel data corresponding to the N primary colors.

12. The method of claim 11, further comprising converting an input signal, having a first color format, to the set of X, Y, Z tristimulus values.

13. The method of claim 12, wherein the first color format is a European Broadcast Union (EBU) YUV format.

14. The method of claim 12, wherein the first color format is a National Television Systems Committee (NTSC) YIQ format.

15. The method of claim 12, wherein the first format is a Society of Motion Pictures & Television Engineers-C (SMPTE-C) color format.

16. The method of claim 12, wherein the first format is an International Telecommunications Union (ITU) standard BT-709 YCbCr color format.

17. A method of converting color image data into a format for display by a display having N primary colors, where N≧3, the method comprising:
(a) receiving an input signal representing color image pixel data in a first format;
(b) converting the received color image pixel data into X, Y, Z tristimulus values; and
(c) converting the X, Y, Z tristimulus values into an output signal suitable for driving a display device having more than three primary colors.

18. The method of claim 17, wherein the output signal comprises N color image pixel data adapted to drive the N primary colors of the display.

19. The method of claim 17, where the first format is one of a European Broadcast Union (EBU) YUV format, a National Television Systems Committee (NTSC) YIQ format, a Society of Motion Pictures & Television Engineers-C (SMPTE-C) color format, or an International Telecommunications Union (ITU) standard BT-709 YCbCr color format.

20. The method of claim 17, further comprising, subsequent to steps (a), (b), and (c):
(d) receiving a second input signal representing second color image pixel data in a second format;
(e) converting the received second color image pixel data into second X, Y, Z tristimulus values; and
(f) converting the second X, Y, Z tristimulus values into the output signal suitable for driving a display device having more than three primary colors.
